(19) United States
(12) Patent Application Publication
(10) Pub. No.: US 2025/0198630 A1
(43) Pub. Date: Jun. 19, 2025

(54) TELESCOPIC EXTENSION WITH QUICK-FASTENING ELEMENTS

(71) Applicant: Accuride International GmbH, Diez (DE)

(72) Inventor: Andreas HEFFEL, Dierdorf (DE)

(73) Assignee: Accuride International GmbH, Diez (DE)

(21) Appl. No.: 18/976,605

(22) Filed: Dec. 11, 2024

(30) Foreign Application Priority Data
Dec. 19, 2023 (DE) 10 2023 135 875.8

(51) Int. Cl. F24C 15/16

(52) U.S. Cl. CPC F24C 15/168

(57) ABSTRACT

Telescopic extension having a stationary inner rail and at least one outer rail mounted displaceably relative to the stationary inner rail, and with front and rear quick-fastening elements that allow quick and easy mounting and removal on a side grid, but still effectively prevent unintentional detachment or lifting of the telescopic extension from the side grid.

### SUBJECT OF THE INVENTION

The present invention relates to a telescopic extension having a stationary inner rail and at least one outer rail mounted displaceably relative to the stationary inner rail between a fully inserted position and a fully extracted position in an insertion direction and in the extraction direction opposite thereto, and having a front quick-fastening element and a rear quick-fastening element, which are fixed to the inner rail of the telescopic extension at a distance from one another. The quick-fastening elements are designed for detachable mounting of the telescopic extension on a side grid, e.g. a side grid for an oven muffle.

The invention also includes the combination of a telescopic extension with a front quick-fastening element and a rear quick-fastening element and a side grid.

### BACKGROUND OF THE INVENTION

Commercially available ovens have devices on the opposite side walls of the oven muffle for sliding in and holding the food carriers (baking trays, baking racks, drip trays, etc.) at different heights within the muffle. Such devices can be projections or groove-shaped cutouts in the inner walls of the muffle. However, side grids with horizontal grid rods are often mounted on the inner walls of the muffle opposite each other for the insertion and holding of the food carriers.

Usually, such side grids have at least two vertical grid bars arranged essentially parallel to each other in the mounted state, as well as several horizontal grid bars arranged at different heights within the muffle, which are attached to and connect the vertical grid bars. In order for a food carrier to be inserted with its lateral edges onto the horizontal grid bars, at least past the front vertical grid bars of the opposite side grids located closer to the muffle opening, the horizontal grid bars extend, at least in the front region of the side grid facing the muffle opening, usually at a distance in front of the plane formed by the vertical grid bars. At the front end, the horizontal bars have an angled end section for connection and attachment to at least the front vertical bars. At the opposite rear end, which extends in the direction of the region of the side grids facing the muffle rear wall, the horizontal grid bars can also have an angled end section for connection to and attachment to the rear vertical grid bars. Alternatively, the horizontal bars can be connected directly to the rear vertical bars at the rear end without an angled end section. In this case, the rear vertical bars of the side grids mounted opposite each other are usually arranged at a slightly smaller distance from each other than the front vertical bars, in order to ensure that the sections of the horizontal bars extending from the front to back vertical bars, extend parallel and thus provide adequate support for food carriers from the front to the back region of the side grids.

To prevent a food carrier from tipping over and falling down when, for example, it is pulled out of the muffle of the oven far enough to process or inspect the food, so that it would tip over at the front end of the horizontal bars, such side grids often have, above a horizontal grid bar as described above, a further horizontal grid bar provided at a small distance, which is sufficiently wide to insert the food carrier between the two horizontal grid bars, but which is also sufficiently narrow that the food carrier can be supported with a rear section of the lateral edge against tipping over at the upper horizontal grid bar.

Modern and higher-quality ovens are additionally equipped with telescopic extensions to hold and move the food carrier. In addition to the easy movement of the food carrier, a further advantage of using telescopic extensions is that, with a sufficient number of movable rail elements, they allow the food carrier to be pulled out far or even completely out of the muffle without the food carrier tipping over. Usually, such telescopic extensions are attached to existing side grids in the oven muffle, whereby a stable, but easily detachable and re-mountable attachment is useful and desirable in order to be able to easily remove and re-insert the telescopic extensions for cleaning or for changing the position height within the muffle or also for cleaning the oven itself, for example by pyrolysis. Various systems are known for the detachable attachment of telescopic extensions to side grids, in which at least one, often two or even more fastening elements are provided for mounting the so-called stationary rail element of the telescopic extension on the side grid.

Fasteners for quick and easy, preferably tool-free assembly and disassembly of a telescopic extension on a side grid often have the disadvantage that the telescopic extension can be unintentionally disconnected from the side grid under certain load situations or other circumstances and fall down. Fasteners designed to prevent this often have the disadvantage that they include safety devices that make mounting and dismounting the telescopic extension laborious and sometimes even require a separate tool.

EP 2 592 968 describes a connecting device for the detachable attachment of a telescopic extension to a side grid of an oven, with two holders fixed at a distance from each other on a stationary rail element of the telescopic extension. The first holder is designed for fastening the telescopic extension in the front region of the side grid facing the muffle opening and comprises a spring element by means of which the holder can be latched on the side grid. The second holder is designed for attaching the telescopic extension in the rear region of a side grid facing the muffle rear wall, in which the horizontal grid bar does not have an angled rear end section at its rear end, but is connected directly in a straight line or laterally welded to the rear vertical grid bar. If the telescopic extension is to be detachably attached to a side grid in which the horizontal grid bar is designed differently at its rear end and has an angled rear end section, a correspondingly differently designed second holder must be used. However, a simple exchange is impossible or at least very laborious, since the holders are welded or glued to the telescopic extension. Thus, different telescopic extensions would have to be manufactured for both types of side grid.

### OBJECT OF THE INVENTION

The object of the present invention was therefore to provide a telescopic extension with fastening elements that eliminate the aforementioned disadvantages of the prior art and that allow quick and easy assembly and disassembly on a side grid, while still effectively preventing unintentional loosening or lifting of the telescopic extension from the side grid.

### DESCRIPTION OF THE INVENTION

This object is achieved by a telescopic extension according to the attached independent claim 1. Embodiments and further designs are apparent from the dependent sub-claims.

The telescopic extension according to the invention has a stationary inner rail and at least one outer rail that is mounted so that it can be displaced in relation to the stationary inner rail between an insertion end position and an extraction end position in an insertion direction and in the extraction direction that is opposite to it.

In this application, regardless of its design, the term inner rail refers to the stationary rail element, which is not movable with respect to a side grid when the telescopic extension is mounted on it by means of the quick-fastening elements. In contrast, the term outer rail refers to the rail element that is linearly movable relative to the inner rail, on which a food carrier, e.g. a cooking tray, is placed or to which a food carrier is connected.

In an embodiment of the invention, the telescopic extension is a partial extension that has as rail elements only the stationary inner rail and the outer rail mounted on it so that it can move linearly. In an alternative embodiment, the telescopic extension is a full extension with at least three rail elements, namely the inner rail, the outer rail and one or more intermediate rails arranged in between, wherein a first intermediate rail is mounted linearly movable on the stationary inner rail and the outer rail is mounted linearly movable on the first intermediate rail or, if more than one intermediate rail is provided, on the outermost intermediate rail.

The fully retracted position of the outer rail relative to the inner rail is referred to as the retracted end position. The fully extended position of the outer rail relative to the inner rail is referred to as the extended end position.

In an embodiment of the invention, the rail elements are mounted on each other such that they can slide by means of rolling elements, preferably balls or rollers. In a further embodiment, at least the inner rail and the outer rail have a C-shaped profile in cross-section, with a rail back formed by the web of the C-profile and with rolling element running surfaces formed on the flanges of the C-profile.

The telescopic extension according to the invention has a front quick-fastening element and a rear quick-fastening element, which are fixed at a distance from each other on the inner rail of the telescopic extension and are designed for a releasable mounting of the telescopic extension on a side grid.

The terms front quick-fastening element and rear quick-fastening element are used to distinguish the two quick-fastening elements linguistically from one another in the sense of a first and a second quick-fastening element. The quick-fastening element that is arranged further along the inner rail in the extraction direction of the telescopic extension than the rear quick-fastening element is referred to as the front quick-fastening element. When the telescopic extension is in the assembled state, the front quick-fastening element is thus arranged closer to the aperture of the furnace muffle, while the rear quick-fastening element is arranged closer to the rear wall of the furnace muffle.

In order to place a food carrier, two telescopic extensions can be mounted to side grids that are located opposite one another in the muffle of an oven. The side grid as such is not part of the telescopic extension with quick-fastening elements claimed in accordance with the invention. The description of essential structural features of a side grid, also in the independent claim 1, serves to define features of the quick-fastening elements, since these are suitable and designed for a releasable mounting of the telescopic extension on such a side grid in accordance with the invention.

Such a side grid has at least one front vertical grid bar, one rear vertical grid bar that is spaced apart from and arranged essentially parallel to the front vertical grid bar, and at least one horizontal grid bar that extends essentially perpendicular to the vertical grid bars and connects them.

The horizontal grid bar has an angled front end section at a front end, which is connected to the front vertical grid bar, extends out of the plane spanned by the two vertical grid bars and, at an angle, merges into a horizontal section of the horizontal grid bar, which extends to the rear vertical grid bar.

Furthermore, the horizontal grid bar has at a rear end opposite the front end either i) equally or similarly to the front end, an angled rear end section which is connected to the rear vertical grid bar, extends out of the plane spanned by the two vertical grid bars and is angled into the horizontal section of the horizontal grid bar, or ii) it is directly connected to the rear vertical grid bar, i.e. without an angled end section.

The rear quick-fastening element of the telescopic extension according to the invention is suitable for attachment to both types of side grids with or without an angled end section of the horizontal grid bar, without the need to change the rear quick-fastening element or even to manufacture different telescopic extensions with different rear quick-fastening elements.

It is understood that the side grid can have several horizontal grid bars of the type described herein at different heights above one another and usually also has them for mounting one or more telescopic extensions at different heights within the furnace muffle.

According to the present invention, the telescopic extension has a rear quick-fastening element which comprises a supporting angle, a first abutment section and a second abutment section arranged offset in relation to the first abutment section in the insertion direction (E), wherein
the first abutment section is designed for engagement with a rear vertical grid bar in the insertion direction (E) and has a surface pointing in the insertion direction (E) for support on a surface of a rear vertical grid bar pointing in the extraction direction (A) when the telescopic slide is mounted on a side grid,
the second abutment section is designed for engagement with a rear vertical grid bar in the insertion direction (E) and has a surface facing in the insertion direction (E) for support on a surface facing in the extraction direction (A) of a rear vertical grid bar when the telescopic slide is mounted on a side grid, and
the support angle connects the first abutment section and the second abutment section in a straight line or at an angle.

A rear quick-fastening element designed in this way has the advantage that it is suitable for detachably mounting the telescopic extension to different commercially available side grids, namely to those in which, in the rear region of the horizontal grid bar, at its rear end, either i) equally or similarly to the front end, has an angled rear end section that is connected to the rear vertical grid bar, extends out of the plane spanned by the two vertical grid bars and extends angled into the horizontal section of the horizontal grid bar, and those in which the horizontal grid bar ii) is directly connected to the rear vertical grid bar at its rear end, i.e. without an angled end section. It is understood that the rear quick-fastening element according to the invention is also suitable for a further variant of side grids, in which two rear vertical grid bars are arranged in the rear region as described herein and the horizontal grid bar has an angled rear end section at its rear end, which is connected to a first of the two rear vertical grid bars in the manner described in i), and in which the horizontal section of the horizontal grid bar in front of the angled section is connected to the second of the two rear vertical grid bars, for example by resting against it and being welded to it. The following description refers to side grids of variants i) and ii), in which the horizontal grid bar is connected to only one rear vertical grid bar.

In the case of side grids in which the horizontal grid bar has an angled rear end section for connection to the rear vertical grid bar, the vertical grid bar is usually located closer to the side wall than in the case of side grids in which the horizontal grid bar is connected directly in linear connection or directly welded on the side to the rear vertical grid bar, in order to ensure that the horizontal section of the horizontal grid bar runs straight from front to back, i.e. essentially parallel to the horizontal section of the horizontal grid bar of the second side grid located on the opposite muffle wall. The rear quick-fastening element according to the invention of the aforementioned type is thus suitable for secure attachment to both types of side grids with different positioning of the vertical grid bars and it would also be suitable for side grids with two rear vertical grid bars at the two positions described. This rear quick-fastening element according to the invention can be used to save costs and achieve flexibility in terms of usability, since it is not necessary to equip telescopic extensions according to the invention with different rear quick-fastening elements for the two different types of side grids, both of which are or may be commercially available.

In an embodiment of this rear quick-fastening element according to the invention, the supporting angle has a cutout or both the supporting angle and the second abutment section have a cutout, which is designed and arranged for the insertion of a horizontal grid bar of a side grid when the telescopic rail is mounted on the side grid.

Such a cutout is advantageous or even necessary for the attachment of the rear quick-fastening element to a side grid, in which the horizontal grid bar is directly connected to the rear vertical grid bar at its rear end, i.e. without an angled end section. In such a side grid, the first abutment section comes into contact with the vertical grid bar, while the second abutment section is arranged closer in the direction of the muffle side wall and must therefore be guided past the horizontal grid bar to mount the rear quick-fastening element. The cutout provides the necessary clearance for the supporting bracket. When mounted, the horizontal grid bar extends through the cutout and the supporting bracket rests on the section of the horizontal grid bar that extends through the cutout.

In an embodiment of the aforementioned rear quick-fastening element according to the invention, the supporting angle has a fixing section for connecting the rear quick-fastening element to the stationary inner rail. Similar to the fastening section of the holder and the supporting section of the anti-derail device on the front quick-fastening element, the fixing section of the rear quick-fastening element is preferably a flat section on the rear quick-fastening element, which is aligned parallel to the rail back of the inner rail and preferably extends from the supporting angle and rests against the rail back of the inner rail and is welded or glued to it.

In an embodiment of the aforementioned rear quick-fastening element according to the invention, the first abutment section and/or the second abutment section has a U-shaped cross-section for gripping around a rear vertical grid bar from a side facing in the extraction direction (A) and from the two sides perpendicular to it. When mounting the telescopic extension on the side grid, the abutment section with a U-shaped cross-section is pushed over the vertical grid bar in the insertion direction until it rests against it in the insertion direction and engages around it with the legs of the U, preventing both further movement in the insertion direction and movement perpendicular to it.

In an alternative embodiment of the aforementioned rear quick-fastening element according to the invention, the first abutment section and/or the second abutment section has an L-shaped cross-section for gripping around a rear vertical grid bar from a side facing in the extraction direction (A) and from a side perpendicular to it. When mounting the telescopic extension on the side grid, the abutment section with L-shaped cross-section is pushed in the insertion direction against the vertical grid bar until the foot of the L-shaped profile rests against it in the insertion direction and the other L-shaped arm is arranged to the side of the vertical grid bar, so that both further movement in the insertion direction and transversely to it in the direction of the other L-shaped arm is prevented. An L-shaped profile of the abutment section may be sufficient to securely fix the rear quick-fastening element, in particular if movement in the other transverse direction, which is not prevented by the profile of the L-shaped leg, is blocked by another component in the assembled state.

It is useful if the supporting angle of the rear quick-fastening element according to the invention has a contact surface for placing and supporting the rear quick-fastening element on a horizontal grid bar. In an embodiment, this contact surface can be a horizontally extending lower edge of the supporting angle. In an alternative embodiment, the supporting angle has a cutout that is open in a vertically downward direction, with a contact surface for supporting the rear quick-fastening element on a horizontal grid bar and with lateral edges extending from the contact surface for gripping around the horizontal grid bar. When the rear quick-fastening element is mounted, the supporting angle with the cutout is guided over the horizontal grid bar and then lowered until the upper inner edge of the cutout rests on the horizontal grid bar. The lateral edges of the cutout can then block sideways movement in the mounted state. This embodiment is suitable, for example, in combination with a first abutment section with an L-shaped cross-section, as described above.

In principle, a quick-fastening element that is suitable for detachably securing the telescopic extension in the front section of the side grid can be used as the front quick-fastening element of the telescopic extension according to the invention. Depending on the design of the side grid, different quick-fastening elements may be suitable. It is expedient that the front quick-fastening element is designed such that, like the rear quick-fastening element according to the invention, it engages securely with the side grid in the front region of the side grid with a movement of the telescopic extension in the insertion direction during assembly.

In a preferred embodiment of the invention, the front quick-fastening element comprises a holder and an anti-lift-out device. In an embodiment, the holder and the anti-lift-out device are designed as separate components. Alternatively, the holder and the anti-lift-out device are firmly connected or can be firmly connected to one another, or they are designed as a single piece.

The holder of this preferred front quick-fastening element has a hook with a receiving area and a hook mouth, whereby an angled front end section at the front end of the horizontal section of the horizontal grid bar of a side grid can be inserted through the hook mouth into the receiving area of the hook. It is useful if the hook mouth is accessible from the insertion direction for the angled front end section to be inserted on the horizontal grid bar when mounting the telescopic extension on a side grid by sliding the hook in the insertion direction over the angled front end section.

Furthermore, the holder of this preferred front quick-fastening element has a retaining portion designed to rest against or engage around the front vertical grid bar of a side grid, which has at least one contact surface facing in the insertion direction (E) for resting against a surface of the front vertical grid bar of a side grid facing in the extraction direction (A). When mounting the telescopic extension on a side grid, the retaining portion is brought into contact or engagement with the front vertical grid bar when the hook is pushed over the angled front end section of the horizontal grid bar in the insertion direction. If the retaining portion is designed to grasp the vertical grid bar, it prevents the holder from moving sideways away from the side grid and in the direction of the muffle interior when the telescopic extension is mounted.

The holder of this preferred front quick-fastening element also has a fastening portion for connecting the holder to the stationary inner rail. In an embodiment, the mounting portion is a flat portion of the holder that is aligned parallel to the back of the inner rail and rests against the back of the inner rail and is welded or glued to it.

The anti-lift device of this preferred front quick-fastening element has a support section, a hook mouth securing section, and a spring section.

In an embodiment of the preferred front quick-fastening element, the supporting section of the anti-lift device is fixedly or detachably connected to the stationary inner rail. Similar to the fastening portion of the holder, the supporting section of the anti-lift device is preferably a flat portion of the anti-lift device that is aligned parallel to the back of the inner rail and rests against the back of the inner rail and is welded or glued thereto. In an alternative embodiment, the supporting section of the anti-lifting device is firmly connected to the holder or is formed integrally with the holder.

The hook-mouth securing section of the anti-lifting device is connected to the supporting section via the spring section and can be moved against a restoring force of the spring section from a securing position in the extraction direction (A) into a non-securing position, so that the hook mouth has a first opening width with the hook-mouth securing section in the unlocking position and a second opening width, determined by the hook-mouth securing section, in the locking position, which is smaller than the first opening width.

To mount the telescopic extension on a side grid, the telescopic extension is moved up to the side grid in such a way that the hook of the front holder is arranged in front of the angled front end section of the Horizontal grid bar. Subsequently, in a single movement in the insertion direction, the hook is pushed over the angled front end section, i.e. the angled front end section is inserted through the hook mouth. The aperture of the hook mouth is enlarged or released by pulling back the hook-mouth securing section in the extraction direction against the spring tension of the spring section. Alternatively, the hook-mouth securing section can be pushed in the extraction direction against the spring tension of the spring section by the force applied when sliding on the telescopic extension, without the hook-mouth securing section being pulled back manually. However, when the reverse disassembly process is performed, the hook-mouth securing section must be manually retracted to prevent unintentional disengagement or removal of the telescopic extension from the side grid. When the angled front end portion is inserted through the hook mouth, the retaining portion of the front holder is brought into contact or engagement with the front vertical grid bar. The front part of the telescopic extension is then lowered with the front quick-fastening element so that the holder's hook rests on the angled front end section and engages with it.

The rear quick-fastening element according to the invention is designed in such a way that it also engages securely with the the rear region of the side grid when the telescopic extension is moved in the insertion direction during the assembly of the front quick-fastening element. Compared to known rear quick-fastening elements, it has the advantage that it can be used simultaneously for two types of commercially available side grids, namely those in which the horizontal grid bar at the rear end has an angled rear end section, equally or similarly as at the front end, which is connected to the rear vertical grid bar, extends out of the plane spanned by the two vertical grid bars and is angled into the horizontal section of the horizontal grid bar, and those in which the horizontal grid bar is directly connected to the rear vertical grid bar at the rear end, i.e. without an angled end section.

The telescopic extension according to the invention allows for quick and easy assembly and disassembly on a side grid and still effectively prevents unintentional loosening or lifting of the telescopic extension from the side grid.

In the preferred front quick-fastening element, the hook-mouth securing section is to be moved from the securing position to an unlocked position by operating it against the spring force of the spring section, in order to increase the opening width of the hook mouth so that it is possible to lift the hook off the angled front end section of the horizontal grid bar. At the same time, the operation of the hook-mouth securing section against the spring force of the spring section is ergonomic and easy. The spring section is accessible from the front of the telescopic extension or the side grid. The movement of the hook-mouth securing section is in the extraction direction and not in a sideways movement perpendicular to the extraction direction, which is why no additional space for moving the hook-mouth securing section must be kept free. This also allows the attachment of an ergonomic and easily accessible operating lever. In addition, the solution according to the invention also allows the provision of an additional cover to shield the telescopic extension in the direction of the interior of the oven muffle, in order to protect the telescopic extension from contamination, without impairing the accessibility and operability of the front holder. In addition, the present invention allows for a simpler spring geometry than, for example, the front fastening element known from EP 2 592 968.

In an embodiment of the preferred front quick-fastening element of the invention, the anti-lift device has, on the hook mouth securing section and/or on the spring section, an bending safeguard that extends from the hook mouth securing section and/or the spring section, which limits and/or and/or preventing movement of the hook mouth securing section in a direction away from the holder's hook and perpendicular to the extraction direction (A) of the telescopic extension and/or for limiting and/or preventing movement of the spring section in the insertion direction (E) of the telescopic extension. Preferably, the bending safeguard is formed as a tongue, a web or an embossing extending from the hook mouth safeguard section and/or the spring section.

When the telescopic extension is mounted on a side grid and the hook of the holder is arranged above the angled end section of the Horizontal grid bar, the hook-mouth securing section serves to limit the lifting of the telescopic extension and to prevent the hook from disengaging from the angled end section of the horizontal grid bar by the angled end section coming to rest against the hook-mouth securing section. If a very large force is applied when lifting the telescopic extension, there is a risk that the stability of the spring section and/or the hook mouth securing section fixed to it is not sufficient to prevent the hook from being lifted out, e.g. if the forces acting on it are great enough to bend the spring section and/or the hook mouth securing section unintentionally. The bending safeguard advantageously limits or prevents such unwanted bending by being configured to extend from the hook-mouth securing section and/or the spring section and to have a free end abut a bearing surface of the inner rail, the holder or the anti-lift device itself or is arranged at a distance therefrom, wherein the contact surface of the inner rail, the holder or the anti-lift device forms a stop for limiting the movement of the hook-mouth securing section in a direction away from the hook of the holder and perpendicular to the extraction direction (A) of the telescopic extension. Preferably, the abutment surface is a vertically upwardly facing surface of the inner rail or of the fastening portion of the holder or of the supporting section of the anti-lift device. In a preferred embodiment, the bending safeguard extends downwardly from the hook-mouth securing portion in a vertical direction or at an acute angle of preferably 1° to 20° relative to the vertical.

According to the invention, the aperture of the hook mouth of the hook on the front holder for the insertion of an angled front end section at the front end of the horizontal section of the side grid into the receiving area of the hook is preferably aligned in the insertion direction (E). The hook mouth securing section extends from the spring section, expediently in the insertion direction (E). In the extraction direction (A), the hook-mouth securing section is fixed to the spring section.

In a further embodiment of the preferred front quick-fastening element, the spring section is formed as a springy sheet metal or a springy tab, the plane or surface of which is arranged perpendicular to the extraction direction (A) and preferably parallel to the front vertical grid bar.

In an embodiment of the preferred front quick-fastening element, the spring section is arranged in such a way that it is in a non-prestressed rest position when the hook mouth securing section is in a securing position and is resiliently prestressed in the extraction direction (A) with a restoring force when the hook mouth securing section is in a release position. Alternatively, the spring portion can still have a bias in the insertion direction (E) even in the securing position, if its return movement is limited by a stop before reaching an unbiassed rest position in the insertion direction (E), for example by coming to bear against the retaining portion of the holder, which bears against the front vertical grid bar or engages around it, or by way of the bending safeguard described above.

In a further embodiment of the preferred front quick-fastening element of the invention, an actuating tab extending in the extraction direction or at an acute angle to the extraction direction is provided on the spring section, on the hook-mouth securing section or on a bending safeguard extending from the hook mouth securing section or the spring section to the inner rail, for operation by an operator to move the hook mouth securing section from a securing position to a release position. Preferably, the actuating tab is formed as a section extending obliquely upward from the upper end of the spring section in the extraction direction, preferably at an angle of about 40° to 70° with respect to the vertical, in one piece with and starting from the spring section. The actuation tab allows for simple and ergonomic actuation to move the hook latch portion in the extraction direction, against the spring force of the spring portion, from a secured position to an unsecured position.

A surface of the fastening portion of the holder extends advantageously substantially parallel and perpendicular to the extraction direction (A). In an embodiment, the surface of the fastening portion also extends parallel to the back of the inner rail and is fixed thereto, preferably by welding or gluing. Alternatively, the surface of the fastening portion can also be arranged perpendicular or oblique to the back of the inner rail, for example for fixing from below to the inner rail.

In a further embodiment of the preferred front quick-fastening element of the invention, the holder has a stabilizing section that extends from the fastening portion and/or another surface of the holder that extends essentially parallel and perpendicular to the extraction direction (A) and parallel to the back of the inner rail, preferably at an essentially perpendicular angle. The angled stabilizing section counteracts twisting of the holder and stabilizes it.

In a first aspect, the present invention relates to a telescopic extension of the type described herein with a front quick-fastening element and a rear quick-fastening element. The side grid as such is not the subject of the present invention according to this first aspect.

In a second aspect, the present invention relates to the combination of a telescopic extension of the type described herein with a front quick-fastening element and a rear quick-fastening element and a side grid, which has the essential structural features also described herein.

Further advantages, features and possible applications of the present invention will become apparent from the following description of embodiments thereof and the associated figures. In the figures, the same elements are designated by the same reference signs.

### FIGURES

FIG. 1 is an isometric representation of an embodiment of a telescopic extension according to the invention mounted on a first type of side grid. The side grid without a telescopic extension mounted on it is also shown in the figure.

FIG. 2 is an isometric representation of the embodiment of the telescopic extension according to the invention, as shown in FIG. 1, mounted on a second type of side grid. The side grid without a telescopic extension mounted on it is also shown in the figure.

FIG. 3 is an enlarged isometric representation of the embodiment of the telescopic extension according to the invention, as shown in FIG. 1, in the region of the front quick-fastening element.

FIG. 4 is an enlarged isometric representation of the embodiment of the telescopic extension according to the invention in accordance with FIG. 1 in the region of the front quick-fastening element, whereby for purposes of illustration only the anti-lift device of the front quick-fastening element is shown and the holder is hidden.

FIG. 5 is an isometric representation of the embodiment of the telescopic extension according to the invention, as shown in FIG. 1, mounted on a second type of side grid, as shown in FIG. 2, where, for the purposes of illustration, only the inner rail of the telescopic extension is shown and other rail elements are hidden.

FIG. 6 is an enlarged isometric representation of the embodiment of the telescopic extension according to the invention in accordance with FIG. 5 in the region of the front quick-fastening element.

FIG. 7 is a representation of the embodiment of the telescopic extension according to the invention in accordance with FIG. 1, viewed vertically from above in the region of the front quick-fastening element.

FIG. 8 is an isometric view of the front quick-fastening element of the embodiment according to FIG. 1, looking at the side of the quick-fastening element facing the inner rail.

FIG. 9 is a side view of the front quick-fastening element of the embodiment according to FIG. 1, looking at the side of the quick-fastening element facing the inner rail.

FIG. 10 is an isometric view of the front quick-fastening element of the embodiment according to FIG. 1, viewed from the side of the quick-fastening element facing away from the inner rail.

FIG. 11 is a side view of the front quick-fastening element of the embodiment according to FIG. 1, viewed from the side of the quick-fastening element facing away from the inner rail.

FIG. 12 shows the anti-lift device of the front quick-fastening element of the embodiment according to FIG. 1 in a view vertically from above (left-hand side) and in an isometric view (right-hand side).

FIG. 13 shows the rear quick-fastening element of the embodiment according to FIG. 1 in an isometric view (top) and in a view vertically from above (bottom).

FIG. 14 shows various enlarged isometric views of the rear quick-fastening element of the embodiment according to FIG. 1, mounted on a first type of side grid (upper right and lower right views) and on a second type of side grid (upper left and lower left views).

FIG. 15 shows an alternative embodiment of the rear quick-fastening element in an isometric view (top view) and in a view vertically from above (bottom view).

FIG. 16 shows various enlarged isometric views of the rear quick-fastening element of the embodiment according to FIG. 15, mounted on a first type of side grid (upper right and lower right view) and on a second type of side grid (upper left and lower left view).

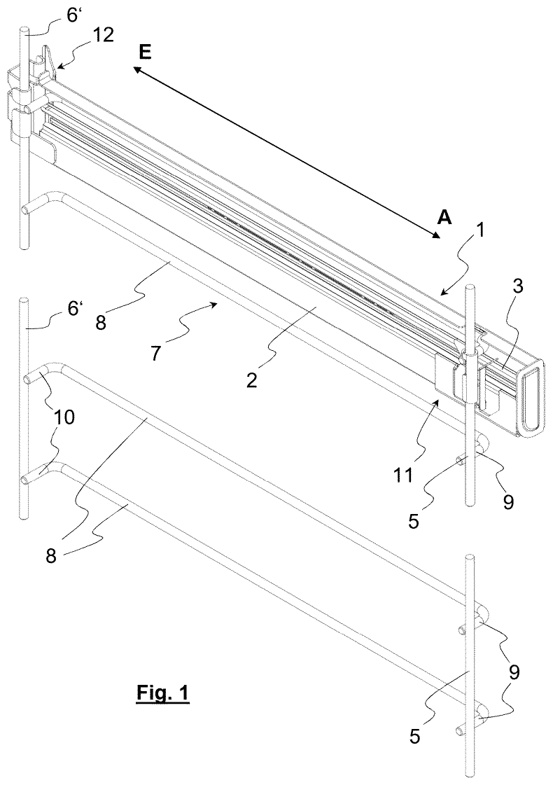

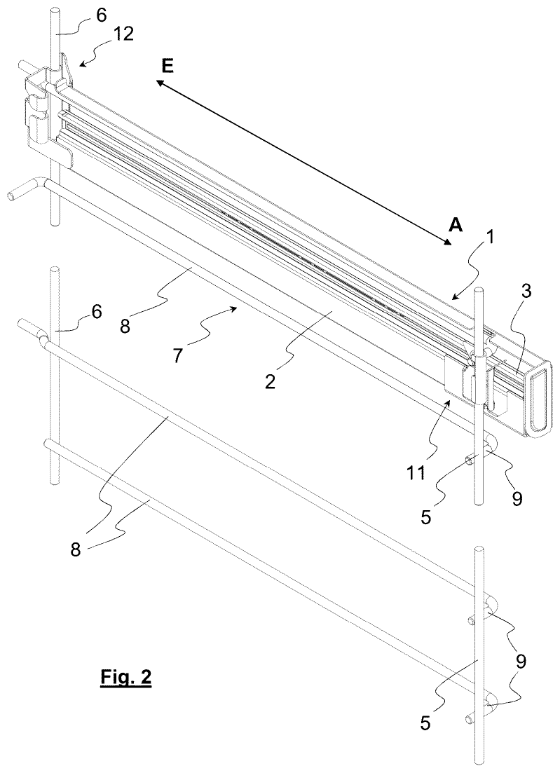

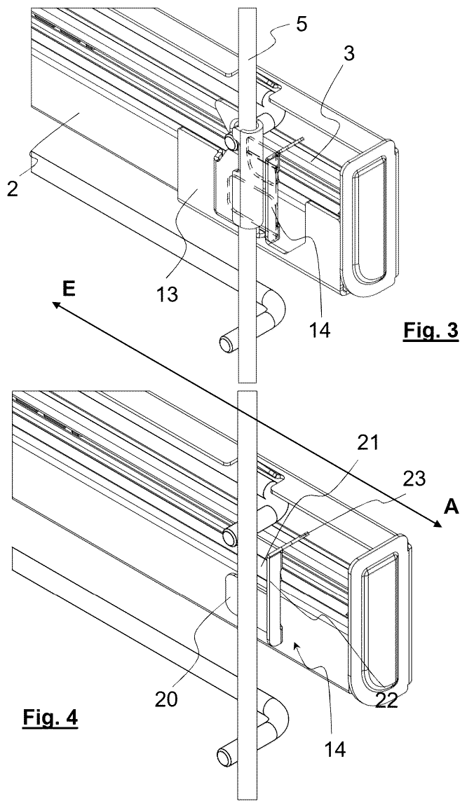

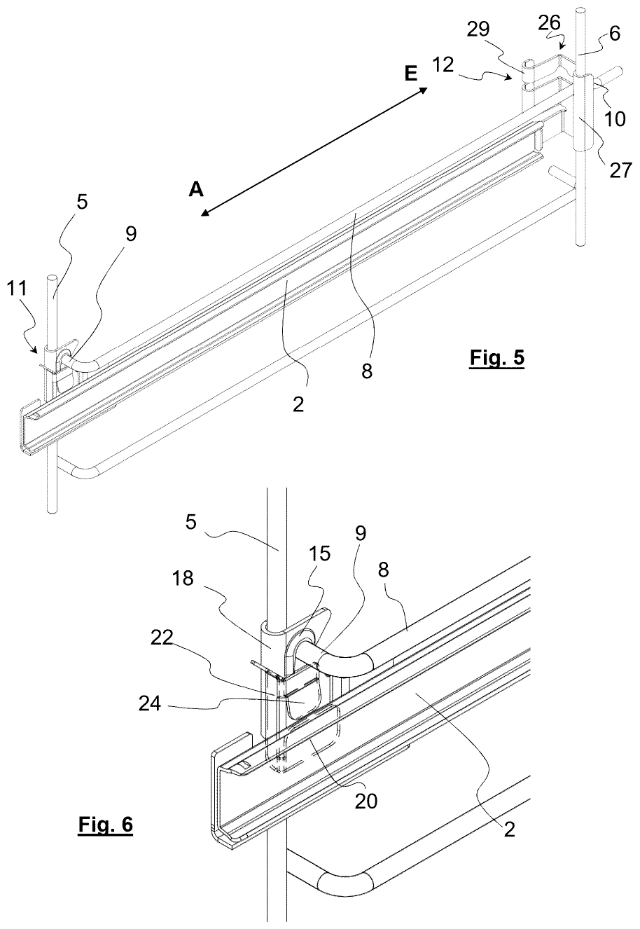

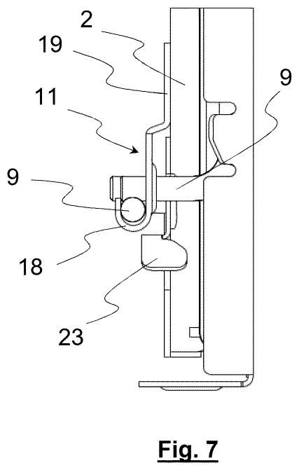

FIGS. 1 to 7 show representations from different viewing directions and partly in enlarged view of an embodiment of a telescopic extension 1 according to the invention, mounted on a side grid 4 of an oven, wherein the side grids 4 in FIGS. 1 and 2 are designed differently in the rear region and are additionally shown in the lower representations of FIGS. 1 and 2 without the telescopic extension 1 mounted thereon.

Both variants of the types of side grids shown in FIGS. 1 and 2 have a front vertical grid bar 5, a rear vertical grid bar 6 or 6′ spaced from and essentially parallel to the front vertical grid bar 5, and at least one horizontal grid bar 7 extending essentially perpendicular to the vertical grid bars 5 and 6 or 6′ and connecting them. Horizontal grid bar 7 has a horizontal section 8 and, at its front end, an angled front end section 9, which is connected to front vertical grid bar 5, extends out of the plane formed by the two vertical grid bars 5 and 6 or 6′ in the direction of the interior of the open muffle and is angled into the horizontal section 8 of the horizontal grid bar 7, which extends to the rear vertical grid bar 6 or 6′.

In the first variant of a side grid shown in FIG. 1, the horizontal grid bar 7 has an angled rear end section 9 at both its rear end, such as at its front end, which is connected to the rear vertical grid bar 6′, extends out of the plane spanned by the two vertical grid bars 5 and 6′, and transitions at an angle into the horizontal section 8 of the horizontal grid bar 7.

In the second variant of a side grid shown in FIG. 2, the horizontal section 8 of the horizontal grid bar 7 extends straight to the rear vertical grid bar 6 and is connected directly to the rear vertical grid bar 6 at its rear end, with the grid bars 6 and 7 resting against each other laterally and being welded together.

The telescopic extension 1 comprises a stationary inner rail 2 and an outer rail 3 that is mounted such that it can be displaced relative to the stationary inner rail 2 between an insertion end position and an extraction end position in an insertion direction E and in the opposite extraction direction A. In the illustrations of FIGS. 1 to 4, an additional cover is arranged above the outer rail 3, which protects the telescopic extension against contamination from the cooking chamber of the baking oven. In the embodiment shown, the inner rail 2 and the outer rail 3 are mounted on each other via a linear ball bearing such that they can slide. The rail elements 2 and 3 have a substantially C-shaped cross-section, with the ball races for the balls of the ball bearing being arranged on the flanges of the C-profiles.

The telescopic extension 1 comprises a front quick-fastening element 11 and a rear quick-fastening element 12, which are welded at a distance from each other on the back of the inner rail 2 of the telescopic extension 1. The telescopic extension is detachably mounted on the side grid by means of the quick-fastening elements 11 and 12.

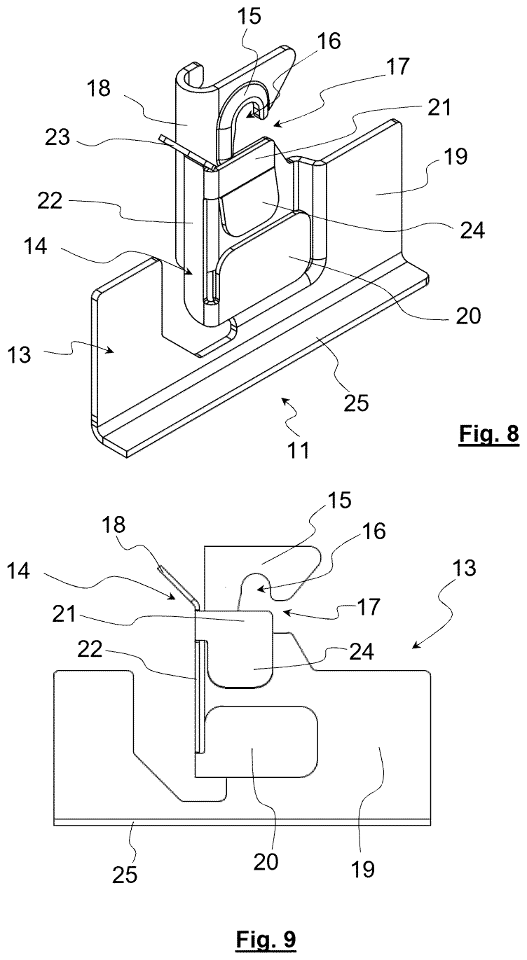

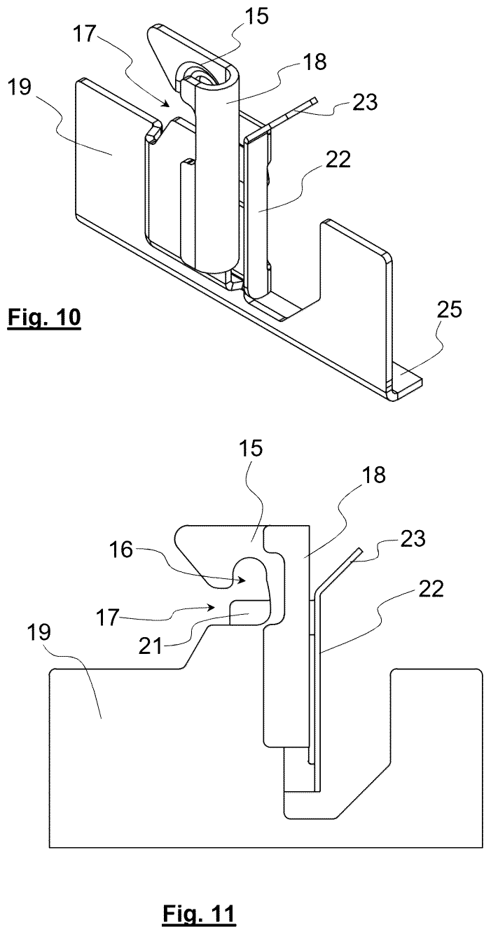

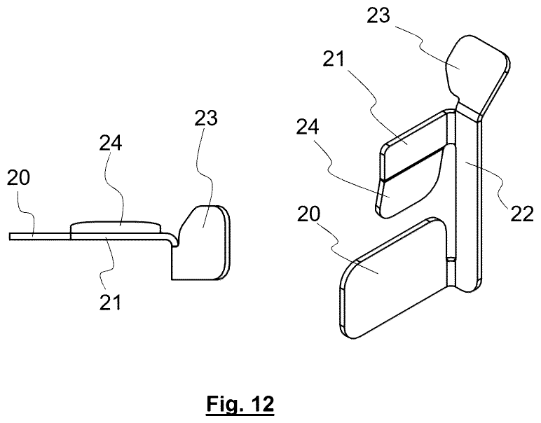

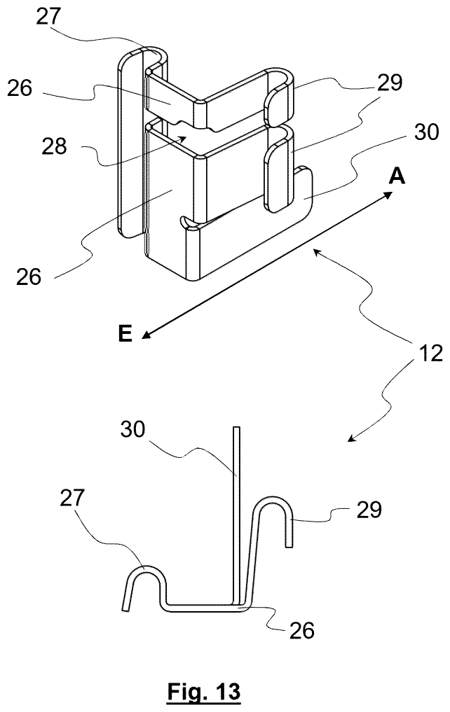

FIGS. 8 to 11 show representations of the front quick-fastening element 11 from different angles, and FIG. 12 shows representations of the anti-lift device 14 of the front quick-fastening element 11 alone.

The front quick-fastening element 11 comprises a holder 13 and an anti-lift device 14, which in the embodiment shown are designed as separate components. The holder 13 is welded to the back of the inner rail 2 via a fastening portion 19, and the anti-lift device 14 is welded to the back of the inner rail 2 via a supporting section 20.

The holder 13 has a hook 15 with a receiving area 16 and a hook mouth 17. When the telescopic extension 1 is installed, the angled front end section 9 at the front end of the horizontal section 8 of the side grid 4 is inserted with a movement of the telescopic extension 1 in the insertion direction E through the hook mouth 17 into the receiving area 16 of the hook 17 and the hook 15 is lowered until it rests on the angled end section 9.

Furthermore, the holder 13 has a retaining portion 18 designed for gripping around the front vertical grid bar 5 of the side grid 4, which in this embodiment has a U-shaped profile in cross-section and has on the inside of the U-profile a contact surface pointing in the insertion direction

E for contact with a surface of the front vertical grid bar 5 pointing in the extraction direction A. When the telescopic extension is mounted on the side grid, the retaining portion 18 is brought into engagement with the front vertical grid bar 5 when the hook 13 is pushed over the angled front end portion 9 of the horizontal grid bar 7 in the insertion direction. When the telescopic extension 1 is in the assembled state, the U-shaped retaining portion 18 engages around the vertical grid bar 5 and prevents the holder 13 from moving sideways away from the side grid in the direction of the muffle interior. Furthermore, the holder 13 has a stabilizing section 25 on its underside, which extends at a substantially right angle and gives the holder bending stability.

The anti-lift device 14, which in this embodiment is designed as a separate component, has a supporting section 20, a hook-mouth securing section 21, a spring section 22 and a bending safeguard 24 that extends at an angle from the hook-mouth securing section 21 to a contact surface on the inner rail 2.

The hook mouth securing section 21 is connected to the supporting section 20 via the spring section 22 and can be moved against a restoring force of the spring section 22 out of a securing position in the extraction direction A into an unlocking position, so that the hook mouth 17 with the hook-mouth securing section 21 in the unlocking position has a first opening width and with the hook-mouth securing section 21 in the locking position has a second opening width, which is determined by the hook-mouth securing section 21 and is smaller than the first opening width.

The spring section 22 is designed as an elastic metal sheet, the plane or surface of which is arranged perpendicular to the extraction direction A and essentially parallel to the front vertical grid bar 5. An actuating tab 23 extends from the upper end of the spring section 22 at an angle to the extraction direction for actuation by an operator to move the hook mouth securing section 21 from a securing position into a non-securing position. Shown herein is the spring section in a non-prestressed rest position with the hook mouth securing section 21 in the securing position.

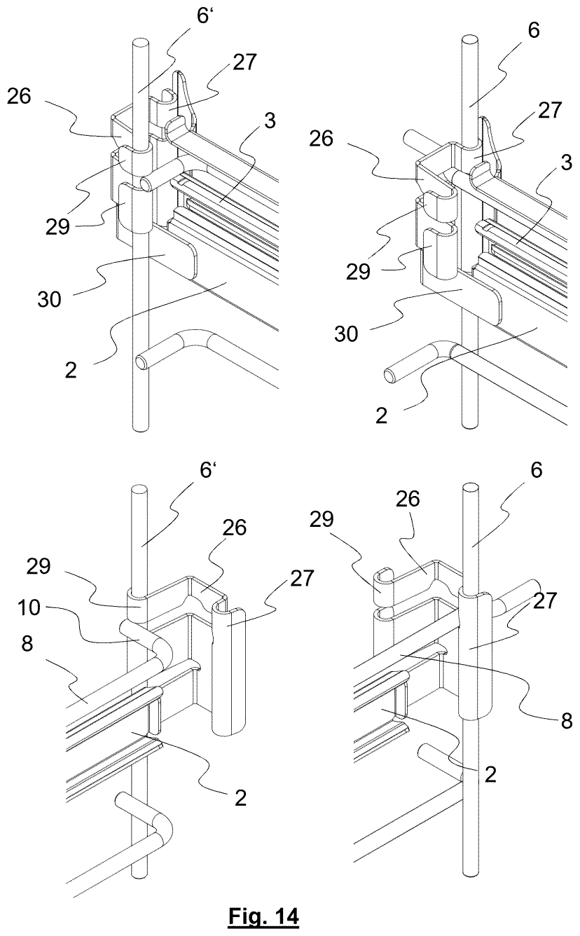

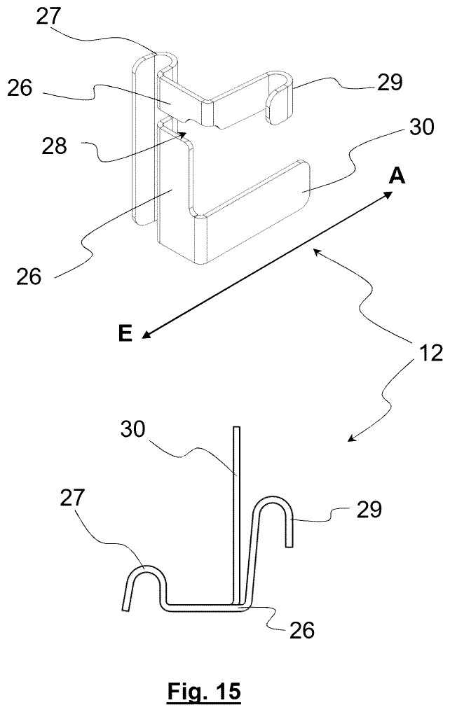

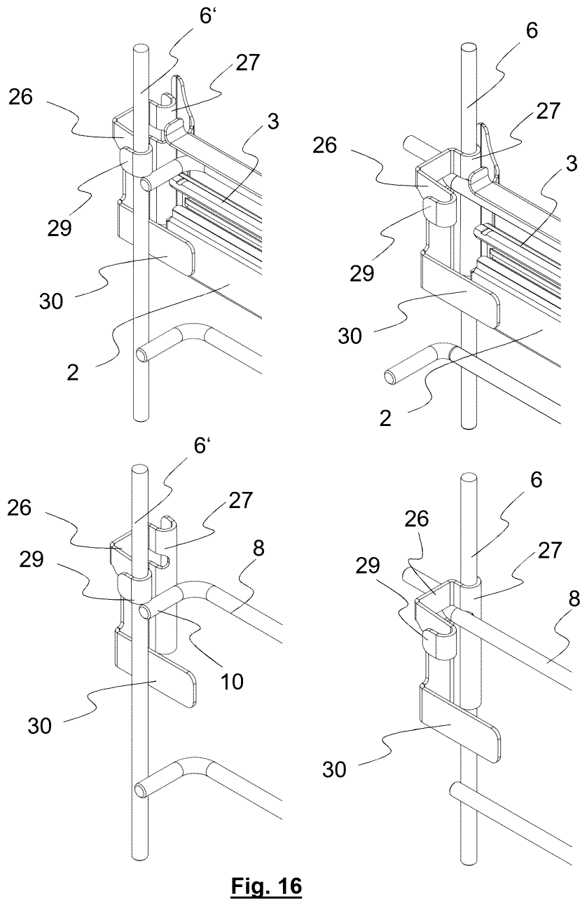

The rear quick-fastening element 12 of a first embodiment, as shown in FIGS. 1, 2 and 5, is shown alone in an isometric view and in a view vertically from above in FIG. 13. FIG. 14 shows various enlarged isometric views of this rear quick-fastening element 12 mounted on the two different types of side grid 4 as shown in FIGS. 1 and 2. FIGS. 15 and 16 show an alternative embodiment of the rear quick-fastening element 12 in representations similar to those in FIGS. 13 and 14.

The rear quick-fastening element 12 has a supporting angle 26, a first abutment section 27 and a second abutment section 29 that is offset in the insertion direction E with respect to the first abutment section 27. The first abutment section 27 and the second abutment section 29 have a U-shaped cross-section for gripping around a rear vertical grid bar 6 or 6′ from a side of the vertical grid bar 6 or 6′ pointing in the extraction direction (A) and from the two sides perpendicular to it.

The supporting angle 26 connects the first abutment section 27 and the second abutment section 29 and has two sections arranged at essentially right angles to one another, at the respective free ends of which the abutment sections 27 and 29 are arranged.

In the first embodiment of the rear quick-fastening element 12 shown in FIGS. 13 and 14, the supporting angle 26 and the second abutment section 29 have a cutout 28, which is designed and arranged for the introduction of a horizontal grid bar 7 of the side grid 4 when the telescopic rail 1 is mounted on the side grid 4. In the second embodiment of the rear quick-fastening element 12, shown in FIGS. 15 and 16, only the supporting angle 26 has a cutout 28, since in this embodiment the second abutment section 29 is designed to be shorter in the vertical direction than in the first embodiment. In the mounted state of the telescopic extension 1 on a side grid 4 of the first variant, in which the horizontal section 8 of the horizontal grid bar 7 extends just to the rear vertical grid bar 6 and as shown in FIG. 2, the horizontal grid bar 7 extends through the cutout 28 and the support bracket 26 rests on the portion of the horizontal grid bar 7 extending through the cutout 28.

In both of the embodiments of the rear quick-fastening element 12 shown in FIGS. 13 to 16, the supporting angle 26 has a securing section 30 welded to the back of the stationary inner rail 2 for connecting the rear quick-fastening element 12 to the stationary inner rail 2.

For the purposes of the original disclosure, it should be noted that all features, as they appear for a person skilled in the art in the present description, drawings and claims, even if they have only been specifically described in connection with certain other features, can be combined both individually and in any combination with other features or groups of features disclosed herein, unless this has been expressly excluded or technical circumstances make such combinations impossible or pointless. The comprehensive, explicit presentation of all conceivable combinations of features is only omitted here for the sake of brevity and readability of the description.

While the invention is presented and described in detail in the drawings and the preceding description, this presentation and description is merely exemplary and is not intended as a limitation of the scope of protection as defined by the claims. The invention is not restricted to the disclosed embodiments.

Modifications to the disclosed embodiments are obvious to a person skilled in the art from the drawings, the description and the appended claims. In the claims, the word “have” does not exclude other elements or steps, and the indefinite article “a” or “an” does not exclude a plurality. The mere fact that certain features are claimed in different claims does not exclude their combination. Reference signs in the claims are not intended to limit the scope of protection.

### LIST OF REFERENCE SIGNS

1 telescopic extension
2 stationary inner rail
3 outer rail
4 side grid
5 front vertical grid bar
6 rear vertical grid bar
6′ rear vertical grid bar
7 horizontal grid bar
8 horizontal section
9 front end section of the horizontal grid bar
10 rear end section of the horizontal grid bar
11 front quick-fastening element
12 rear quick-fastening element
13 holder
14 anti-lift device
15 hook
16 receiving area
17 hook mouth
18 retaining portion
19 fastening portion
20 supporting section
21 hook-mouth securing section
22 spring section
23 actuating tab
24 bending safeguard
25 stabilizing section
26 supporting angle
27 first abutment section of the supporting angle
28 cut-out
29 second abutment section of the supporting angle
30 fixing section
E insertion direction
A extraction direction

1. A telescopic extension
having a stationary inner rail and at least one outer rail mounted displaceably relative to the stationary inner rail between a fully inserted position and a fully extracted position in an insertion direction (E) and in the extraction direction (A) opposite thereto, and
with a front quick-fastening element and a rear quick-fastening element, which are fixed at a distance from one another to the inner rail of the telescopic extension,
wherein the quick-fastening elements are designed for releasable mounting of the telescopic extension on a side grid, which has at least
a front vertical grid bar, a rear vertical grid bar arranged at a distance from and essentially parallel to the front vertical grid bar, and at least one horizontal grid bar extending essentially perpendicular to the vertical grid bars and connecting them,
whereby the horizontal grid bar has at a front end an angled front end section which is connected to the front vertical grid bar, extends out of the plane spanned by the two vertical grid bars and extends at an angle into a horizontal section of the horizontal grid bar, which extends to the rear vertical grid bar, and
wherein the horizontal grid bar has, at a rear end opposite the front end,
i) an angled rear end section which is connected to the rear vertical grid bar, extends out of the plane spanned by the two vertical grid bars and transitions at an angle into the horizontal section of the horizontal grid bar, or
ii) is connected directly to the rear vertical grid bar,
wherein the rear quick-fastening element has a supporting angle, a first abutment section and a second abutment section arranged offset in relation to the first abutment section in the insertion direction (E),
wherein the first abutment section is configured for engagement with a rear vertical grid bar in the insertion direction (E) and has a surface facing in the insertion direction (E) for support on a surface of a rear vertical grid bar pointing in the extraction direction (A) when the telescopic slide is mounted on a side grid,
wherein the second abutment section is configured for engagement with a rear vertical grid bar in the insertion direction (E) and has a surface facing in the insertion direction (E) for support on a surface of a rear vertical grid bar pointing in the extraction direction (A) when the telescopic slide is mounted on a side grid, and
wherein the supporting angle connects the first abutment section and the second abutment section in a straight line or at an angle.

2. The telescopic extension according to claim 1,
wherein the supporting angle has a cutout or the supporting angle and the second abutment section have a cutout which is designed and arranged for the introduction of a horizontal grid bar of a side grid when the telescopic rail is mounted on the side grid.

3. The telescopic extension according to claim 1,
wherein the supporting angle has a fixing section for connecting the rear quick-fastening element to the stationary inner rail.

4. The telescopic extension according to claim 1,
wherein the first abutment section and/or the second abutment section have a U-shaped cross section for gripping around a rear vertical grid bar from a side facing in the extraction direction (A) and from the two sides perpendicular thereto, or
wherein the first abutment section and/or the second abutment section have an L-shaped cross-section for gripping around a rear vertical grid bar from a side pointing in the extraction direction (A) and from a side perpendicular thereto.

5. The telescopic extension according to claim 1,
wherein the supporting angle has a bearing surface for placing and supporting the rear quick-fastening element on a horizontal grid bar, or
wherein the supporting angle has a cutout with a bearing surface for supporting the rear quick-fastening element on a horizontal grid bar and with lateral edges extending from the bearing surface for engaging around the horizontal grid bar.

6. The telescopic extension according to claim 1,
wherein the front quick-fastening element comprises a holder and an anti-lift device, which are designed as separate components or are firmly connected or connectable to one another or are designed in one piece,
wherein the holder
has a hook with a receiving area and a hook mouth, wherein an angled front end section at the front end of the horizontal section of a side grid can be inserted through the hook mouth into the receiving area of the hook,
has a retaining portion designed to rest against or engage around the front vertical grid bar of a side grid, which has at least one contact surface pointing in the insertion direction (E) for contact with a surface of the front vertical grid bar of a side grid pointing in the extraction direction (A), and
has a fastening section for connecting the holder to the stationary inner rail, and
wherein the anti-lift device has a supporting section, a hook-mouth securing section and a spring section,
wherein the supporting section is firmly or detachably connected to the stationary inner rail or firmly connected to the holder or is formed integrally with the holder,
wherein the hook-mouth securing section is connected to the supporting section via the spring section and can be moved against a restoring force of the spring section from a securing position in the extraction direction (A) into a non-securing position, so that the hook mouth having the hook-mouth securing section in the unlocking position has a first opening width and having the hook-mouth securing section in the locking position has a second opening width determined by the hook-mouth securing section, which is smaller than the first opening width.

7. The telescopic extension according to claim 6,
wherein the anti-lifting safeguard on the hook mouth securing section and/or on the spring section furthermore has a bending safeguard extending from the hook mouth securing section and/or the spring section which is arranged and designed to limit and/or prevent movement of the hook mouth securing section in a direction away from the hook and perpendicular to the insertion direction (E) of the telescopic extension and/or to limit and/or prevent movement of the spring section in the insertion direction (E) of the telescopic extension, the bending safeguard preferably being designed as a tab, a web or an embossing extending from the hook mouth safeguard section and/or the spring section.

8. The telescopic extension according to claim 6, wherein
the holder and the anti-lift-out device are manufactured as separate components, each in one piece, from bent sheet metal, wherein the holder is attached, preferably welded, to the inner rail via the fastening section, and wherein the anti-lifting device is fastened, preferably welded on, to the inner rail via the supporting section.

9. The telescopic extension according to claim 6,
wherein the aperture of the hook mouth of the hook is aligned for the introduction of an angled front end section at the front end of the horizontal section of a side grid into the receiving area of the hook in the insertion direction (E) and/or
wherein the hook mouth securing section extends in the insertion direction (E) starting from the spring section.

10. The telescopic extension according to claim 6,
wherein the spring section is formed as a springy sheet metal or a springy tongue, the plane or surface of which is arranged perpendicular to the extraction direction (A) and preferably parallel to the front vertical grid bar,
wherein the spring section is preferably arranged such that it is in a non-prestressed rest position when the hook mouth securing section is in a securing position and is resiliently prestressed with a restoring force in the extraction direction (A) when the hook mouth securing section is in an unlocking position.

11. The telescopic extension according to claim 6,
wherein an actuating tab is provided on the spring section, on the hook-mouth securing section or on a bending safeguard extending in the extraction direction or at an acute angle to the extraction direction, the actuating tab extending in the extraction direction or at an acute angle to the extraction direction for actuation by an operator to move the hook mouth securing section from a securing position into a non-securing position.

12. The telescopic extension according to claim 6,
wherein a surface of the fastening section of the holder extends essentially parallel and perpendicular to the extraction direction (A) and/or
wherein the holder has a stabilizing section that extends at least from the mounting section, preferably from a surface of the mounting section of the holder that extends essentially parallel and perpendicular to the extraction direction (A), angled, preferably essentially perpendicular to the mounting section.

13. A combination of the telescopic extension according to claim 1 and a side grid for a furnace muffle, wherein the side grid
has a front vertical grid bar, a rear vertical grid bar arranged at a distance from and essentially parallel to the front vertical grid bar, and at least one horizontal grid bar extending essentially perpendicular to and connecting the vertical grid bars,
wherein the horizontal grid bar has at a front end an angled front end section which is connected to the front vertical grid bar, extends out of the plane defined by the two vertical grid and passes at an angle into a horizontal section of the horizontal grid bar, which extends to the rear vertical grid bar, and
whereby the horizontal grid bar has, at a rear end opposite the front end,
i) an angled rear end section which is connected to the rear vertical grid bar, extends out of the plane spanned by the two vertical grid bars and merges at an angle into the horizontal section of the horizontal grid bar, or
ii) is directly connected to the rear vertical grid bar,
wherein the front end section of the horizontal grid bar extends through the receiving area of the hook so that the hook rests on the front end section when the telescopic extension is mounted on the side grid.
